(19) United States
(12) Patent Application Publication
(10) Pub. No.: US 2002/0005199 A1
(43) Pub. Date: Jan. 17, 2002

(54) Connecting part of a breathing mask

(76) Inventor: Klaus Schmidtke, Berlin (DE)

Correspondence Address: WOOD, PHILLIPS, VANSANTEN,, CLARK & MORTIMER, 500 W. Madison Street, Suite 3800, Chicago, IL, 60661, US

(21) Appl. No.: 09/746,591

(22) Filed: Dec. 21, 2000

(30) Foreign Application Priority Data
Dec. 23, 1999 (DE) 199 63 598.6

(51) Int. Cl. A62B 18/08

(52) U.S. Cl. 128/206.23; 128/201.12

(57) ABSTRACT

This invention relates to a connecting part of a breathing mask for connecting components such as filter, speech diaphragm, or exhalation valve that is inserted directly into the eye-protecting lens and guarantees easy assembly and disassembly.

It is the object and problem of this invention to create a connecting part of a breathing mask for connecting components such as filter, speech diaphragm, or exhalation valve that is inserted directly into the eye-protecting lens and guarantees secure fixing, easy assembly and disassembly.

This problem is solved according to the invention by creating a connecting part of a breathing mask that is directly placed in the eye protecting lens where a clamp-shaped locking member (1) is sitting on the rim of the eye-protecting lens in such a way that the clamping elements (3) of the locking member move into engagement with the receptacles (4) of a connecting piece (2), where the connecting piece (2) comprises holding elements (5) and (8) designed to interlock with said locking member (1), and where a fixing element (11) is sitting on the rim of the eye-protecting lens.

### DESCRIPTION

This invention relates to a connecting part of a breathing mask for connecting components such as filter, speech diaphragm, or exhalation valve that is inserted directly into the eye-protecting lens and guarantees easy assembly and disassembly.

The state of the art includes a multitude of solutions in which the connecting part for connecting components such as filter, speech diaphragm, etc. is placed in the mask body. These solutions are mostly accompanied by disadvantages; for example, that the area they take reduces the size of the eye-protecting lens, which limits the field of vision of the person wearing the mask.

DE-PS 23 04 866 only describes how hinge pins for internal lens wipers can be led through a lining in the eye-protecting lens, which cannot be compared with the solution according to this invention.

One solution is known from a breathing mask in the market where a connecting part is directly incorporated in the eye-protecting lens. In this solution, a clip for holding the connecting part is engaged with recesses in the rim of the eye-protecting lens. The disadvantages of this solution are higher manufacturing costs for the eye-protecting lens, complicated handling and the fact that the connecting piece is secured at only two force absorption points.

It is the object and problem of this invention to create a connecting part of a breathing mask for connecting components such as filter, speech diaphragm, or exhalation valve that is inserted directly into the eye-protecting lens and guarantees secure fixing as well as easy assembly and disassembly.

This problem is solved according to the invention by creating a connecting part of a breathing mask that is directly placed in the eye-protecting lens where a clamp shaped locking member is sitting on the rim of the eye-protecting lens in such a way that the clamping elements of the locking member move into engagement with the receptacles of a connecting piece, where the connecting piece comprises holding elements designed to interlock with said locking member, and where a fixing element is sitting on the rim of the eye-protecting lens.

The solution according to the invention enables easy assembly and disassembly of the connecting part and provides a high level of safety for the person wearing the mask for its intended purpose as force from the connected parts such as a filter is absorbed at a minimum of three points.

Because of the design of the locking member, the connecting part according to the invention of a breathing mask is an especially space-saving solution featuring easy-handling short assembly paths, and direct and short flow of force.

This solution intentionally abstains from expensive piercing of the eye-protecting lens or its rim.

The invention will be explained in more detail below, with reference to an embodiment as shown in the figures.

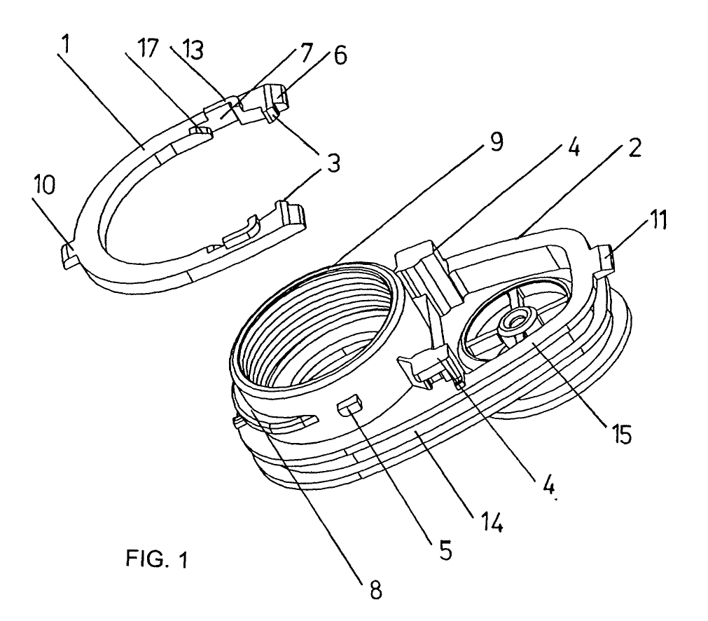

FIG. 1 Locking member 1 and connecting piece 2

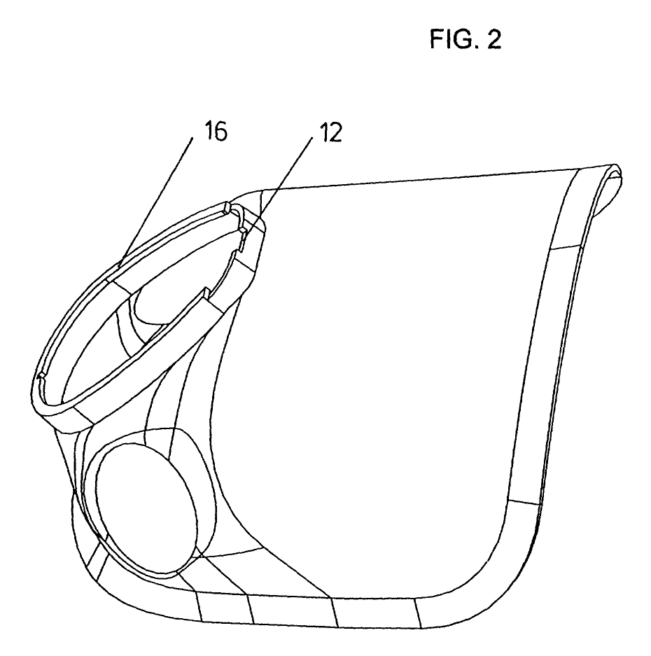

FIG. 2 Eye-protecting lens

When assembling the connecting part of the invention, the connecting piece 2 is pushed from inside through an opening of the eye-protecting lens so that the fixing element 11 is inserted in a groove 12 in the rim of the lens and the bearing surface 15 sits close to the rim 16 of the lens. Subsequently, the locking member 1 is placed from outside upon the eye-protecting lens so that it encompasses the connecting cylinder 9 while the recesses 7 and their antagonistic holding elements act as a guidance until the locking member fits tightly with the rim 16 of the lens. The design according to the invention of locking member 1 where the distance between the clamping elements 3 is smaller than the diameter of the connecting cylinder 9 causes preliminary fixation during assembly: the locking element 1 cannot slip off, the only other way it can go would be in opposite direction for disassembly. When pressing lightly on the locking member 1 and pushing it towards the receptacles 4 of the connecting piece 2, the clamping elements 3 of locking member 1 become engaged with the receptacles 4 of the connecting piece 2. In this process, locking element 1 slides underneath the holding elements 5 and 8 that act as mating holder. This process is facilitated by the rising chamfers 6 and 17 on the locking member and additional rising chamfers on the holding elements 5.

For easy disassembly after use, e.g. for cleaning the eye-protecting lens and the connecting part, the locking member 1 is equipped with gripping elements 13. When these gripping elements are slightly pressed outwards, the clamping elements 3 can be unclamped from the receptacles 4, and the locking member can be pushed in the opposite posite direction of the engagement until the recesses 7 and holding elements 5 are positioned upon each other. The piece can now easily be detached by moving it against the direction of assembly.

To seal the locking member against the eye-protecting lens, an O-ring is inserted into groove 14 of connecting piece 2 before the latter is inserted into the lens as described. This O-ring presses against the rim of the lens after assembly and ensures safe sealing against the ambient atmosphere.

The design of locking member 1 and connecting piece 2 in combination with the eye-protecting lens results in force absorption from the connecting part at six points: holding elements 5 and 8, receptacles 4, and fixing element 11.

The fixing elements 10 and 11 are also used for holding a protective cap.

The holding elements 5, the recesses 7 and the fixing element 11 are not required in another embodiment wherein force is absorbed at three points. This design reduces manufacturing costs while still providing a fully operational variant.

We claim:

1. A connecting part of a breathing mask placed directly in the eye protecting lens wherein a clamp-shaped locking member (1) is sitting on the rim of the eye-protecting lens in such a way that the clamping elements (3) of the locking member move into engagement with the receptacles (4) of the connecting piece (2), where the connecting piece (2) comprises holding elements (5) and (8) designed to interlock with said locking member (1), and where a fixing element (11) is sitting on the rim of the eye-protecting lens.

2. The connecting part of a breathing mask according to claim 1 wherein for ease of assembly said locking member (1) comprises rising chamfers (6) and recesses (7), said connecting piece (2) comprises said holding elements (5) and (8) as undercutting elements, and the spacing between said clamping elements (3) is smaller than the diameter of the connecting cylinder (9).

3. The connecting part of a breathing mask according to claims 1 and 2 wherein said locking member (1) comprises a fixing element (10) and said connecting piece (2) comprises a fixing element (11) for holding a protective cap.

4. The connecting part of a breathing mask according to claims 1 through 3 wherein said locking member (1) is equipped with gripping elements (13) for easy disassembly.
